(19) United States
(12) Patent Application Publication
(10) Pub. No.: US 2008/0086315 A1
(43) Pub. Date: Apr. 10, 2008

(54) INTERNET-BASED RENTAL SYSTEM AND METHOD

(76) Inventor: Alan A. Beatrez, Prior Lake, MN (US)

Correspondence Address: SCHWEGMAN, LUNDBERG & WOESSNER, P.A., P.O. BOX 2938, MINNEAPOLIS, MN, 55402, US

(21) Appl. No.: 11/530,776

(22) Filed: Sep. 11, 2006

(51) Int. Cl. G06Q 10/00; G06Q 30/00

(52) U.S. Cl. 705/1

(57) ABSTRACT

Embodiments described herein include Internet-based rental system and method that enable individuals to rent or to make available for rent, various types of assets from a common website. The system and method described include rental processing software that runs on the rental website to allow individuals to offer for rent or to rent assets conveniently over the Internet.

### FIELD

Embodiments of the inventive subject matter relate generally to an E-commerce method and system in the area of rentals, and more specifically, to a method and system for connecting owners of assets offered for rent and renters wanting to rent the assets via the Internet.

### LIMITED COPYRIGHT WAIVER

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever. Copyright 2006, Al Beatrez.

### BACKGROUND

Conventional rental centers typically use a similar business model which can be restrictive in terms of product offerings, cost competitiveness and the ability to reach a maximum number of clientele.

One element of the business model entails investing in rental assets that provide the highest dollar utilization and time utilization. Dollar utilization is the rental revenue expressed over the original cost of the equipment. Both metrics drive toward maximizing gross margins and return on investment. If a rental asset does not provide the expected financial results, one option is to sell the asset and reinvest the capital in a different type of rental asset with the goal of obtaining improved results. This methodology can have a narrowing, limiting effect on the breadth of assets offered for rent within the rental industry as a whole.

From the perspective of rental costs, conventional rental centers are burdened with a variety of expenses that have an unfavorable impact on rental rates. A few of the most significant are wages, facility related costs, service of debt and sales and marketing expenses in addition to the amortized cost of the rental asset. These additional expenses make the rental rates seem excessive. Furthermore, depending upon the rental duration, renting the asset could be more expensive than purchasing the asset directly.

A third restrictive business element within the rental center industry is the location of the business, not unlike other “brick and mortar” businesses. The location plays an important role in providing customers with visibility of and access to the business. The visibility and access along with the general locale are factors that result in a finite level of clientele typically within a given radius of the business.

### SUMMARY

An embodiment of the present invention includes a method of providing at least one asset for rent by an owner via Internet. The method includes establishing a website in the Internet. The website is used as an interface for the owner to provide the asset for rent and for a renter to rent the asset. The method also includes checking membership of the owner by the website. If the owner is not a member of the website, the owner is prompted to select a unique user name and password, as well as to input personal and financial data to establish a membership for the owner. The method further includes receiving and storing information of the asset by the website. The information of the asset is inputted by the owner of the asset. The method additionally includes confirming the decision of the owner regarding the asset for rent by the website. If confirmed by the owner, the owner is automatically debited for a listing fee and the website is automatically credited for the listing fee. The asset is then identified for rent by the website, and information pertaining to the asset is listed, whereby the asset is made available to rent in the website via Internet.

Another embodiment includes a method of renting at least one asset by a renter via Internet, wherein the asset is made available to rent by an owner via Internet. The method includes establishing a website in Internet, wherein the website is used as an interface for the owner to provide the asset for rent and for the renter to rent the asset. The method also includes checking membership of the renter by the website. If the renter is not a member of the website, the renter is prompted to select a unique user name and password, as well as to input personal and financial data to establish the membership for the renter. When finding the asset wanted to rent, the renter may correspond via the website with the owner of the asset to exchange information regarding to the asset. The method further includes electronically completing rental transaction if the renter decides to rent the asset, whereby the financial transaction for renting the asset is automatically initiated and executed.

One other embodiment includes a method of listing at least one asset wanted to rent by a renter via Internet. The method includes establishing a website in the Internet, wherein the website is used as an interface for the renter and an owner of the asset. The method also includes checking membership of the renter by the website. If the renter is not a member of the website, the renter is prompted to select a unique user name and password, as well as to input personal and financial data to establish the membership for the renter. The method further includes receiving by the website a searching criteria inputted from the renter and searching through the website for the asset wanted to rent. The method additionally includes saving the searching criteria in the website by the renter if the asset wanted to rent is unavailable to rent in the website, whereby the asset wanted to rent by the renter is listed in the website as an asset wanted and unavailable to rent.

Another embodiment includes a method of providing an asset for rent by an owner and renting the asset by a renter via Internet. The method includes establishing a website in the Internet, wherein the website is used as an interface for the owner to provide the asset for rent and for the renter to rent the asset. The method also includes checking membership of the owner by the website. If the owner is not a member of the website, the owner is prompted to select a unique user name and password, as well as to input personal and financial data to establish a membership for the owner. The method further includes receiving and storing, in the website, information of the asset inputted from the owner. The method additionally includes confirming the decision of the owner of the asset for rent by the website. If confirmed by the owner, the owner is automatically debited and the website is automatically credited for a listing fee. The asset is then identified for rent by the website and information pertaining to the asset is listed, whereby the asset is made available to rent in the website via Internet. The method also includes checking membership of the renter by the website. If the renter is not a member of the website, the renter is prompted to select a unique user name and password, as well as to input personal and financial data to establish the membership for the renter. When finding the asset wanted to rent, the renter may correspond via the website with the owner of the asset to exchange information regarding to the asset. The method further includes electronically completing rental transaction if the renter decides to rent the asset, whereby the financial transaction for renting the asset is automatically initiated and executed. The method further permits a renter to extend the current rental duration for a rented asset utilizing process steps to transact the process similar to the original rental transaction. The method further permits the owner to initiate follow-up transactions against the renter after the rental period is complete including the ability to record and transact late fees if the rented asset is not returned on the expected return date and to record and transact costs associated with damage or loss.

One other embodiment includes a system for renting an asset provided by an owner via Internet. The system includes a website in the Internet, wherein the website is used as an interface for the owner to provide the asset for rent through a computer and one or more input devices and output devices, as well as for the renter to rent the asset through a computer and one or more input and output devices. The system also includes a mechanism for checking membership of the owner in the website. If the owner is not a member of the website, the owner is prompted to select a unique user name and password as well as personal and financial data to establish a membership for the owner. The system further includes a mechanism for receiving and storing information of the asset inputted from the owner in the website. The system additionally includes a mechanism for confirming the decision of the owner to put the asset for rent in the website. The system also includes a mechanism for debiting the owner and crediting the website to automatically debit the owner and credit the website for a listing fee after the decision of the owner to list the asset for rent is confirmed. The system further includes a mechanism for identifying the asset for rent in the website and listing information pertaining to the asset, whereby the owner is able to make the asset available to rent in the website. The system also includes a mechanism for checking membership of a renter by the website, if the renter is not a member of the website, the renter is prompted to select a unique user name and password as well as personal and financial data to establish the membership for the renter. The system further includes a mechanism for providing communications between the owner and the renter, whereby the renter is able to correspond via the website with the owner of the asset to exchange information regarding to the asset. The system additionally includes a mechanism for electronically completing rental transaction, whereby if the renter decides to rent the asset, the financial transaction for renting the asset is automatically initiated and executed after electronically completing rental transaction. The system further includes a mechanism to permit a renter to extend the current rental duration for a rented asset utilizing process steps to transact the process similar to the original rental transaction. The system further includes a mechanism to permit the owner to initiate follow-up transactions against the renter after the rental period is complete including the ability to record and transact late fees if the rented asset is not returned on the expected return date and to record and transact costs associated with damage or loss.

### DESCRIPTION OF THE FIGURES

Embodiments of the invention are illustrated by way of example and not limitation in the Figures of the accompanying drawings in which:

FIG. 1 is a schematic diagram illustrating primary elements and relationships of a method and system for connecting renters with owners of assets offered for rent.

FIG. 2 is a detailed diagram illustrating primary elements and relationships of a method and system for connecting renters with owners of assets offered for rent.

FIG. 3 is a flow diagram illustrating various functional selections comprising the method and system that operates in accordance with the present invention.

FIG. 4 is a flow diagram illustrating the establishment of a membership within the website.

FIG. 5 is a flow diagram illustrating an approach for listing assets for rent over the Internet.

FIG. 6 is a flow diagram illustrating search capabilities and associated functions of the present invention.

FIG. 7 is a flow diagram illustrating an approach for renting assets over the Internet.

FIG. 8 is a flow diagram illustrating an approach of saving criteria of asset wanted to rent over the Internet.

FIG. 9 is a flow diagram illustrating an approach to provide closure on the rental contract by the owner.

FIG. 10 is a flow diagram illustrating an approach of obtaining rental activity history from the website.

FIG. 11 is a diagram of a computer and network system upon which embodiments of the invention may be implemented.

### DETAILED DESCRIPTION

Although detailed embodiments of the invention are disclosed herein, it is to be understood that the disclosed embodiments are merely exemplary of the invention that may be embodied in various and alternative forms. Specific structural and functional details disclosed herein are not to be interpreted as limiting, but merely as a basis for teaching one skilled in the art to variously employ the Internet-based rental system and method embodiments. Throughout the drawings, like elements are given like numerals.

With growing demand for rental assets and the aforementioned limitations within the current rental center industry today, a less restrictive approach to renting assets is highly desired.

A less restrictive rental method is achievable through the convergence of owners of idle or seldom used assets with individuals wanting to rent them rather than renting from a conventional rental center. With a subset of the population purchasing assets others would rather rent, these owners are in a position to offer the seldom used asset to those that would prefer to rent. With a great portion of the population being in a position to offer some type of asset for rent, the variety of assets that could be offered is practically unlimited.

From a cost perspective, because individual owners aren't burdened with the expenses the conventional rental center is, the rental rates offered by these individuals can be very cost effective for renters. In this arrangement, not only is it favorable for the renter, the owner is also able to recoup some of the value tied into the idle or seldom used asset.

To effectively and efficiently connect owners of assets offered for rent with individuals wanting to rent, the use of an Internet website configured for electronic commerce in the area of rentals can replace the need for the conventional rental center. Through the use of a web site with search capabilities, the visibility and access to assets offered for rent is essentially unlimited. Clients could search for assets by the name of the asset, geographic location in which to rent, rental rates, etc.

An Internet based rental center connecting owners of assets with individuals wanting to rent clearly has numerous advantageous for both owner and renter over the traditional rental center.

The description of inventive subject matter described herein is arranged in the following order:

1. Overview of the rental method and system

2. Connectivity of owner and renter

3. Selecting functions

4. Establishing membership

5. Listing an asset for rent

6. Searching for an asset

7. Renting an asset

8. Listing an asset wanted to rent

9. Providing rental closure

10. Obtaining rental activity history

11. Diagram of a computer system and Internet network

### 1. OVERVIEW OF THE RENTAL METHOD AND SYSTEM

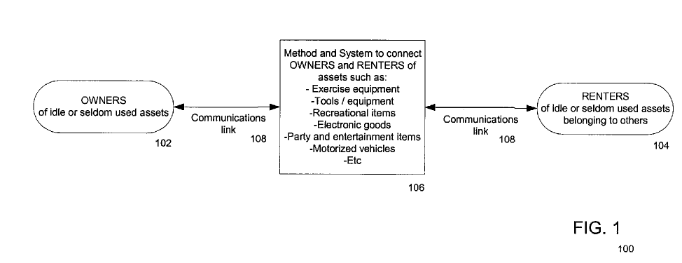

One embodiment of the invention described herein, illustrated generally at 100 of FIG. 1, includes a system 106 that connects renters 104 with owners 102 of assets offered for rent.

The term “renter” refers to a customer seeking to utilize an asset owned by someone else, the “owner”, in exchange for a modest user fee referred to as “rent”. In this rental relationship, the terminology of renting can be synonymous with leasing. As used herein, the term “assets” refers to any personal property that could be rented to others. Examples of “assets” include but are not limited to tools, equipment, exercise equipment, recreational assets, electronic goods, motorized vehicles, instruments, merchandise, plants, animals, etc. By enabling a personal property owner with a capability of offering any owned asset up for rent, the variety and extent of products offered to customers is practically unlimited which is in stark contrast to the variety of assets offered by typically rental centers.

To enable the connection of renters of assets with owners of assets offered for rent, the system 106 utilizes a communications link 108. Examples of suitable communication links include but are not limited to, the Internet, local area networks (LANs), wide-area networks (WANs), wireless connections, optical or wire links, or combinations of these links. The communication link 108 of the system entails and enables two way communications from owner to renter and renter to owner.

### 2. CONNECTIVITY OF OWNER AND RENTER

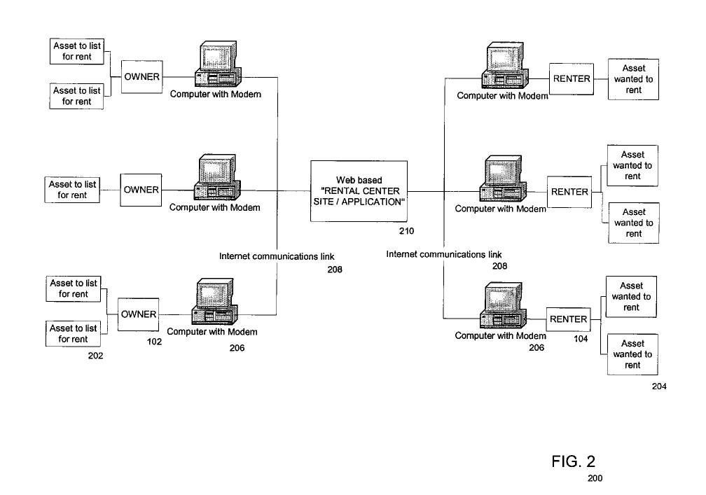

FIG. 2 is a detailed diagram 200 depicting the primary elements and relationships of the system 106 to connect renters 104 with owners 102 of assets offered for rent. According to one embodiment, an owner 102 of an asset offered for rent, utilizes a personal computer with modem or wireless capabilities 206 connects to the Internet via a communications link 208 and then interfaces with a rental center website 210. This is further detailed in Section 10 titled “Diagram of a computer system and Internet network”.

According to another embodiment on the renter side of the system, individuals (renters) 104 wanting to rent an asset utilize a personal computer with modem or wireless capabilities 206, that connects to the Internet via a communications link 208 and then interfaces with the rental center website 210. The website permits the owner and renter to interface, communicate and complete all aspects of the rental process as described in the following sections.

### 3. SELECTING FUNCTIONS

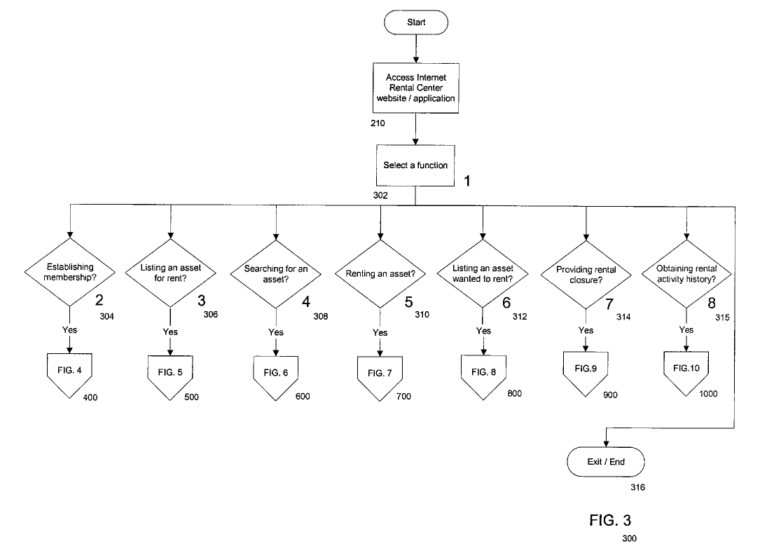

FIG. 3 is a flow diagram 300 depicting the various functional selections in the system and method that operates in accordance with embodiments described herein. When the rental website 210 is accessed as described in the previous section, an individual may select a function 302 related to the system and method enabling the connection of owners offering the assets for rent with consumers wanting to rent via the Internet. The website includes one or more interfaces accessible by the user for one or more of the following:
Becoming a member 304
Listing an asset for rent 306
Searching for an asset 308
Renting an asset 310
Listing an asset wanted to rent 312
Providing rental closure 314
Obtaining rental activity history 315
Exiting the website 316

### 4. ESTABLISHMENT OF MEMBERSHIP

According to one embodiment, one specific function the user can select through the interface is to establish a membership 304 to the website.

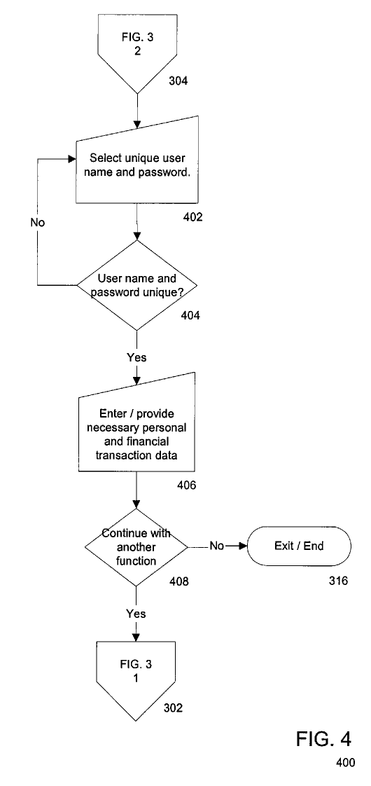

FIG. 4 is a flow diagram 400 illustrating the establishment of a system membership within the Internet-based website. Data about the member, including the member's name, address, identification of the article for rent, location of article for rent, and contact information is collected and stored in one or more databases. For some embodiments, the databases are searchable and accessible by members.

By establishing membership accessibility to the website, the user is then able to engage in the listing of an asset for rent, renting an asset, listing an asset wanted to rent and obtaining rental activity history through one or more interfaces of the website. Through the process of becoming a member, the individual selects a unique user name and password 402 to provide the individual with a unique identification as a user as well as providing the member with a level of transactional security. If the user selects a name and password which is not unique 404 within the rental center website, the user is notified, through a website interface, to select a new name and password. Once the unique user name and password are established, the user then provides personal and financial transaction data 406 to enable the successful execution of financial rental transactions either as an owner offering assets for rent or as a renter of assets wanted to rent. This transaction data is stored in one or more databases.

Once the personal data is entered thereby completing the membership function, a user interface on the website displays an option to continue with another function 408. The user has options of either exiting 316 the rental website or proceeding with the selection of another function 302 as described in Section 3 or as depicted in FIG. 3.

### 5. LISTING AN ASSET FOR RENT

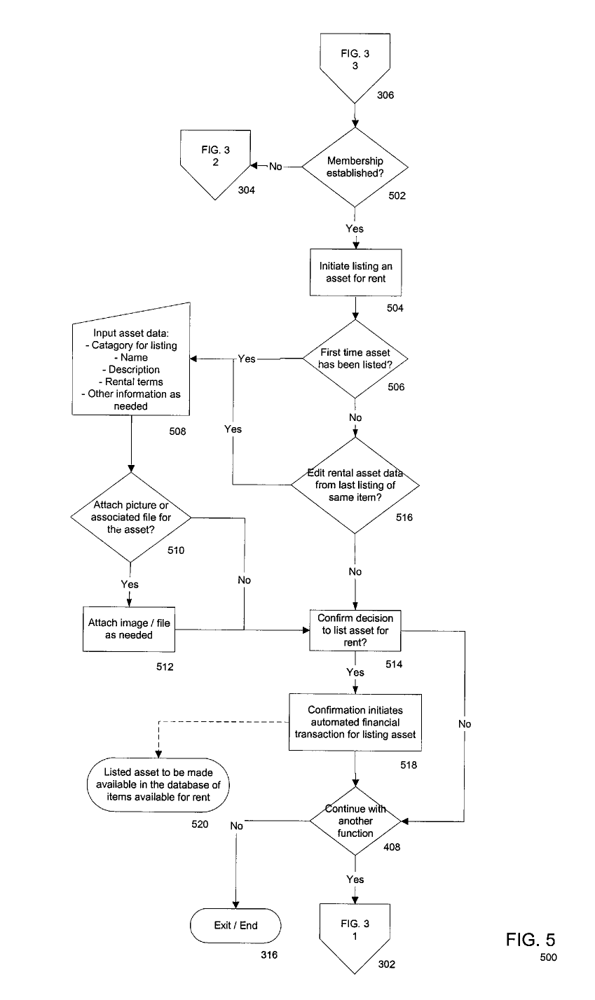

According to one embodiment, from the Internet-based website the user is able to initiate the listing of an asset for rent. FIG. 5 is a flow diagram 500 depicting an approach for listing assets for rent over the Internet. Once this function is selected from a user interface on the website, the user is asked if a membership to the website had been previously established 502 since the listing of an asset requires the user to have a unique user name and password as well as be enabled for financial transactions. If the user had not previously established a membership, the user is directed to initiate becoming a participating member 304 prior to listing an asset for rent from a user interface. Once the user's membership is established, the user proceeds to initiate listing an asset for rent 504, through an asset listing interface. If it is the first time the asset is being listed 506, the owner inputs the necessary asset data 508 into the website including but not limited to or restricted to:
Category type for the listing
Name of asset
Description of the asset
Rental terms and conditions
Other information as needed

The owner is also offered the opportunity to attach associated files or pictures of the asset 510 to further enhance the marketing of the asset, through the interface. Regardless of whether or not the user would decide to attach an image of the asset 512, when complete the owner confirms the decision to list the asset for rent 514. If confirmed, an automated financial transaction occurs 518 debiting and crediting the owner of the asset and the rental center website, respectively, for the appropriate listing fee. The user then provides the option to continue with another function 408. The user either exits 316 the rental website or proceeds with the selection of another function 302 as described in Section 3 or depicted in FIG. 3.

According to one embodiment, if the member is listing an asset previously listed for rent, the member is permitted to utilize the previous asset data and or edit the data 516 accordingly. The ability to utilize past data in the reenlisting process is available for some embodiments for a specific period of time until the previous data is no longer saved in the website database. When the reenlisting is complete, the owner confirms the decision to list the asset for rent 514 and if confirmed, an automated financial transaction occurs 518 debiting the owner of the asset and crediting the rental center website, respectively, for the appropriate listing fee.

After the listing of the asset for rent is complete, the listed asset is made available in the database of assets available for rent 520. The user is then provided the option to continue with another function 408. The user may either exit 316 the rental website or proceed with the selection of another function 302, using the appropriate user interface as described in Section 3 or depicted in FIG. 3.

### 6. SEARCHING FOR AN ASSET

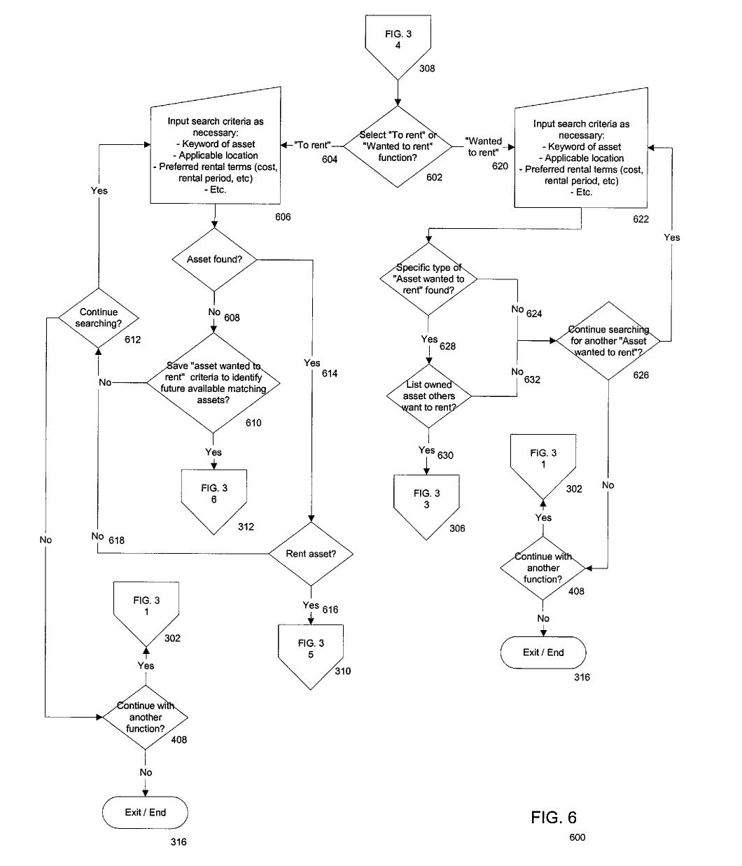

FIG. 6 is a detailed flow diagram 600 depicting search capabilities and associated functions of system embodiments described herein. According to one embodiment, the individual select to search the rental center website database of “assets to rent” or “assets wanted to rent” 602 depending upon the needs or desires of the individual. If the individual is interested in renting an asset from others listing on the website, the individual selects the “to rent” interface 604 and searches the database of assets “offered for rent”. On the other hand, if the user is interested in offering an asset for rent that someone else had listed on the website database as an asset wanted to rent, the user selects the “wanted to rent” interface 620 and searches the database of assets “wanted to rent”.

When searching the “assets to rent” database, the user inputs search criteria 606 as necessary such as the keyword of the asset, applicable location to rent the asset, preferred rental terms, etc. If the asset was not found 608, the user is given the option to save the “asset wanted to rent” criteria to enable identifying future matching available assets offered for rent 610. This function is described in further detail in Section 8 titled “Listing an asset wanted to rent” 312. If the user does not want to save the “asset wanted to rent” criteria, could the user then continues searching 612 the website database or proceeding with another function 408. The user then either exits 316 the rental website or proceeds with the selection of another function 302 as described in Section 3 or depicted in FIG. 3.

According to one embodiment, when searching within the website database of “assets to rent”, if the asset is found 614 and the user wants to rent the asset 616, the user proceeds to the function “renting an asset” 310 described in Section 7. If the asset is found 614 but the user decides not to rent the listed asset 618, the user then either continues searching the database 612 or proceeds with another function 408. The user then either exits 316 the rental website or proceeds with the selection of another function 302 as described in Section 3 or depicted in FIG. 3.

According to one embodiment, when searching within the website database of “assets to rent”, if the asset is found 614 and the user wants to rent the asset 616, the user is directed to the function “renting an asset” 310 described in Section 7. If the asset is found 614 but the user decides not to rent the listed asset 618, the user then continues searching the database 612 or proceeding with the option to continue with another function 408. The user either exits 316 the rental website or proceeds with the selection of another function 302 as described in Section 3 or depicted in FIG. 3.

When searching the “wanted to rent” 620 database, the user inputs search criteria 622 as necessary such as the keyword of the asset, applicable location, preferred rental terms, etc. If the “asset wanted to rent” item was not found 624, the user would select either the option to continue searching for another “asset wanted to rent” 626 or the option to proceed with another function 408. The user could then exit 316 the rental website or proceed with the selection of another function 302 as described in Section 3 or depicted in FIG. 3.

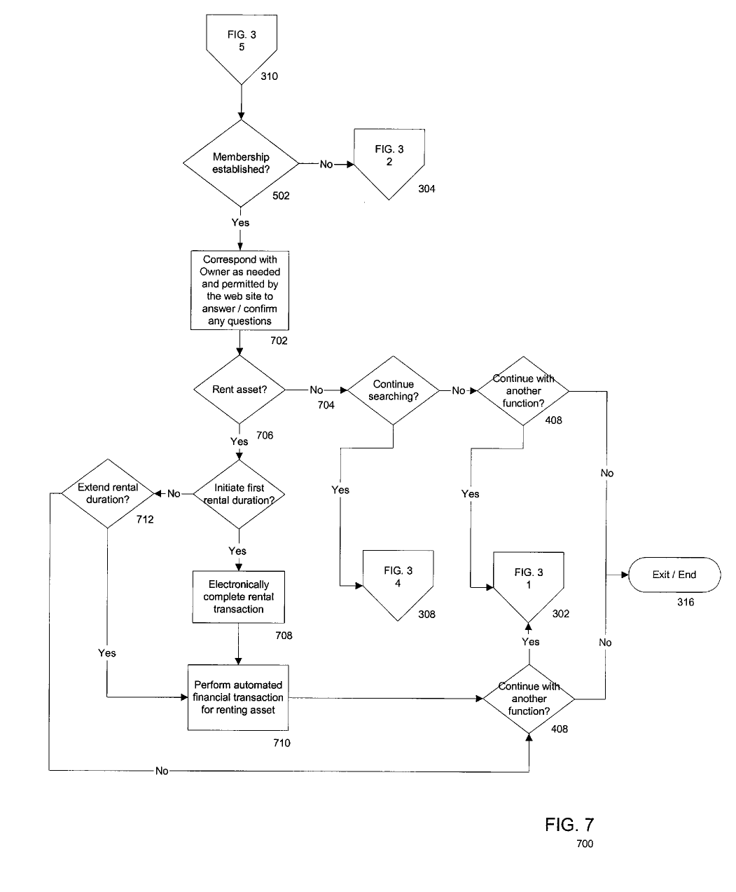

If the “asset wanted to rent” item was found 628 in the database and the user owned and wanted to list the “wanted to rent” asset 630, the user would then proceed to the function titled “listing an item for rent” 306 described in Section 7 or depicted in FIG. 7. If the “asset wanted to rent” item was found 628 in the database but the user did not want to list the “wanted to rent” asset 632, the user would select either the option to continue searching for another “asset wanted to rent” 626 or the option to proceed with another function 408. The user could then either exit 316 the rental website or proceed with the selection of another function 302 as described in Section 3 or depicted in FIG. 3.

### 7. RENTING AN ASSET

FIG. 7 is a flow diagram 700 outlining an approach for renting assets over the Internet. According to one embodiment, the user of the website could search for an asset to rent as described in the previous section. If the asset was found and the individual wanted to pursue renting it, the user would be asked if a membership to the website had been previously established 502 since the renting of an asset would require the user to have a unique user name and password as well as be enabled for financial transactions. If the user had not previously established a membership, they would be directed to initiate becoming a participating member 304 prior to renting an asset. Once the user's membership is established, the user could then begin corresponding 702 with the owner of the asset via an exchange of information pertaining to the asset and or any aspect of the rental process for that specific asset over the website. If the member decided they did not want to rent the listed asset 704, they could continue searching 308 the website database or continue with another function 408 as described in Section 3 titled “Selecting functions” 302.

If the participating member decided to rent the asset 706, they would electronically complete the rental transaction process 708 consisting of but not limited to:
Identifying the asset to rent
Identifying the rental duration
Identifying the start date and time to begin the rental
Providing user name and password to complete the transaction
Completion of the transaction would initiate and execute the financial transaction 710 required to rent the asset.

The user would then be provided the option to continue with another function 408. The user could either exit 316 the rental website or proceed with the selection of another function 302 as described in Section 3 or depicted in FIG. 3.

If during the first rental duration the participating member decided to extend the rental duration 712, they would electronically complete the rental transaction process 708 similar to that for the first rental duration.

8. LISTING AN “ASSET WANTED TO RENT”

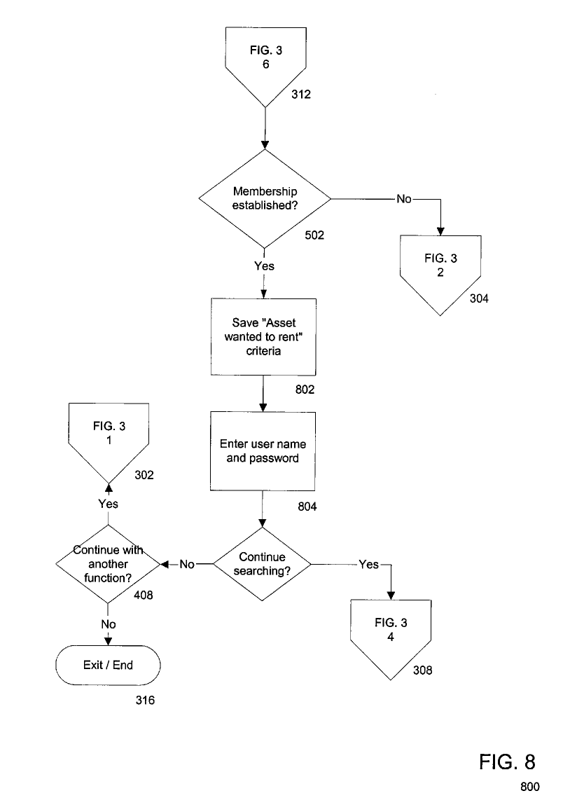

FIG. 8 is a flow diagram 800 illustrating the process to save “asset wanted to rent” criteria on the Internet website. According to one embodiment, if an individual wanted to save “asset wanted to rent” criteria 802 within the rental center website database, the user would be asked if a membership to the website had been previously established 502 since the process of saving the criteria would require the user to have a unique user name and password. If the user had not previously established a membership, they would be directed to initiate the process to become a member 304 prior to saving “asset wanted to rent” criteria.

According to one embodiment, once an individual has established a membership 502 to the website as described in Section 4, they would then be able to save “asset wanted to rent” criteria 802 within the rental center website database. This assumes the asset was searched for and not found meeting the listed criteria. Saving the “asset wanted to rent” criteria under the member's name and password 804 would enable an automated electronic notification process to occur notifying the individual if an asset is listed meeting all the saved criteria.

After completing the function of saving “asset wanted to rent” criteria, the user could continue searching the database 308 or proceed with another function 408. The user could then either exit 316 the rental website or proceed with the selection of another function 302 as described in Section 3 or depicted in FIG. 3.

### 9. PROVIDING RENTAL CLOSURE

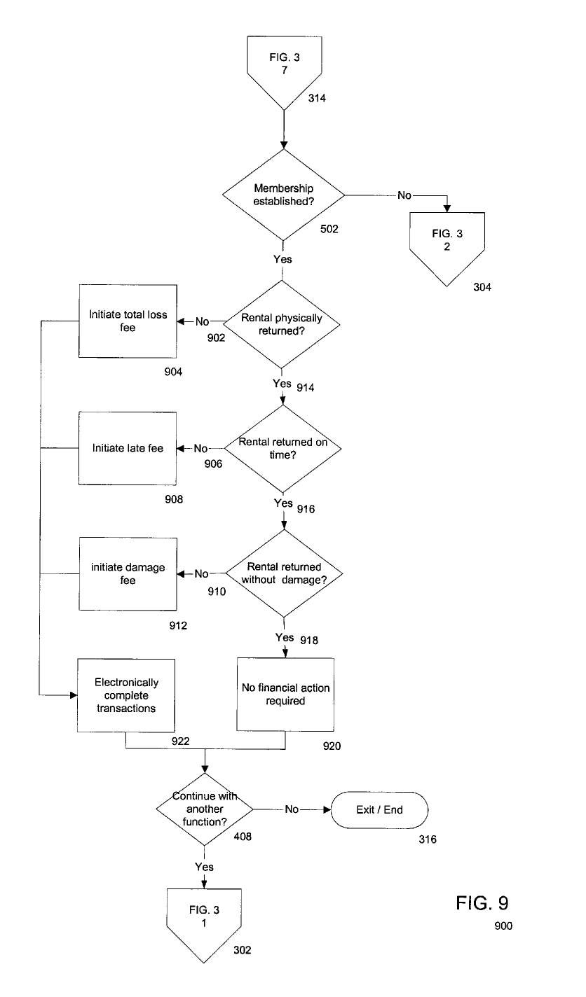

FIG. 9 is a flow diagram 900 depicting an approach to provide closure on a completed rental contract between the owner and the renter. According to one embodiment, if an owner wanted to initiate the closure on a rental contract 314 within the rental center website database, the user would be asked if a membership to the website had been previously established 502 since the process of providing rental closure would require the user to have a unique user name and password. If the user had not previously established a membership, they would be directed to initiate the process to become a member 304.

According to one embodiment, the owner would determine if the rented asset was physically returned after the rental period expired. If the rented asset was not returned after a period of time past the expected return date 902, the owner could consider the asset to be a complete loss. The owner would initiate a total loss fee 904 transaction identifying the rented asset as a complete loss thereby initiating and executing a financial transaction 922 debiting the renter and crediting the owner for the market value of the item.

According to another embodiment, if the rented asset was physically returned to the owner, the owner would determine if it was returned after the expected return date. If returned after the expected return date 906, the owner would initiate a late fee 908 transaction identifying the duration of time the rented asset was late. This would initiate and execute a financial transaction 922 debiting the renter and crediting the owner for the appropriate late fee amount.

According to another embodiment, if the rented asset was physically returned to the owner, the owner would determine if it was returned in a physical condition similar to when it was initially rented. If returned damaged 910, the owner would initiate a damage fee 912 transaction identifying the extent of damage. This would initiate and execute a financial transaction 922 debiting the renter and crediting the owner for the appropriate damage fee amount.

According to another embodiment, if the rented asset was physically returned to the owner 914 on or before the expected return date 916 and was found to be in a physical condition similar to when it was initially rented 918, the owner could close out the rental contract without initiating any financial transaction 920.

After completing the function of providing closure on a completed rental contract, the user would be provided an option to continue with another function 408. The user could either exit 316 the rental website or proceed with the selection of another function 302 as described in Section 3 or depicted in FIG. 3.

### 10. OBTAINING RENTAL ACTIVITY HISTORY

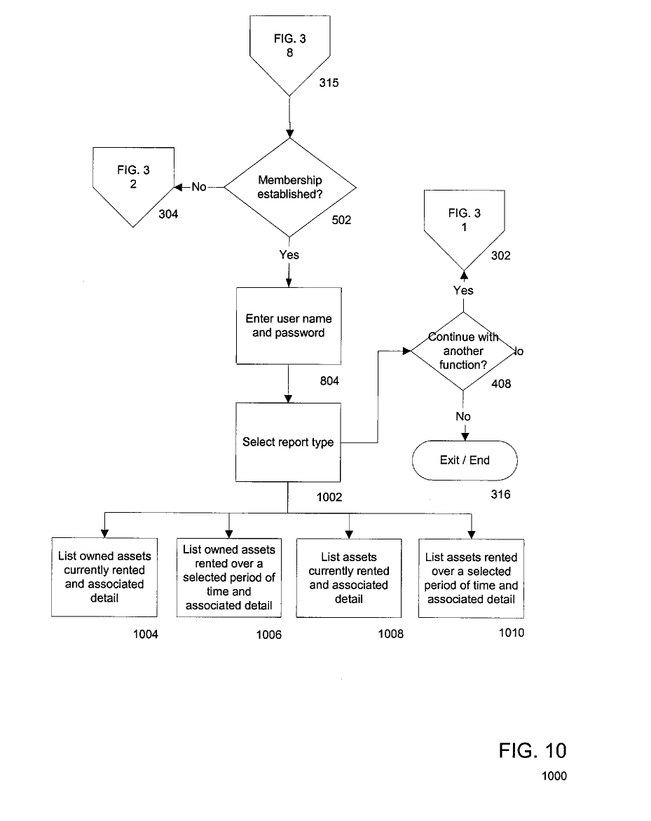

FIG. 10 is a flow diagram 1000 depicting an approach to obtain rental activity history from the Internet website. According to one embodiment, if an individual had established a membership 502 to the website as described in section 4, they would then be able to obtain various types of rental activity history. If the user had not previously established a membership, they would be directed to initiate the process to become a member 304 prior to obtaining various types of rental activity history. By entering the member's user name and password 804, they would then be able to select a report type 1002 from the following, but not be limited to:
Owned items currently rented and associated detail 1004
Owned items rented over a period of time and associated detail 1006
Items currently rented and associated detail 1008
Items rented over a period of time and associated detail 1010

After completing the function of obtaining rental activity history, the user could proceed with another function 408 by either exiting 316 the rental website or proceeding with the selection of another function 302 as described in Section 3 or depicted in FIG. 3.

### 11. DIAGRAM OF A COMPUTER SYSTEM AND INTERNET NETWORK

The approach and method of listing assets for rent or for renting said assets is relevant for any type of rental application. With today's technology, the Internet is one of the best mechanisms to use to enable the connection of owners and renters of assets. To enable this type of approach, the invention may be implemented through the use of computer hardware, computer software and or a combination of the two.

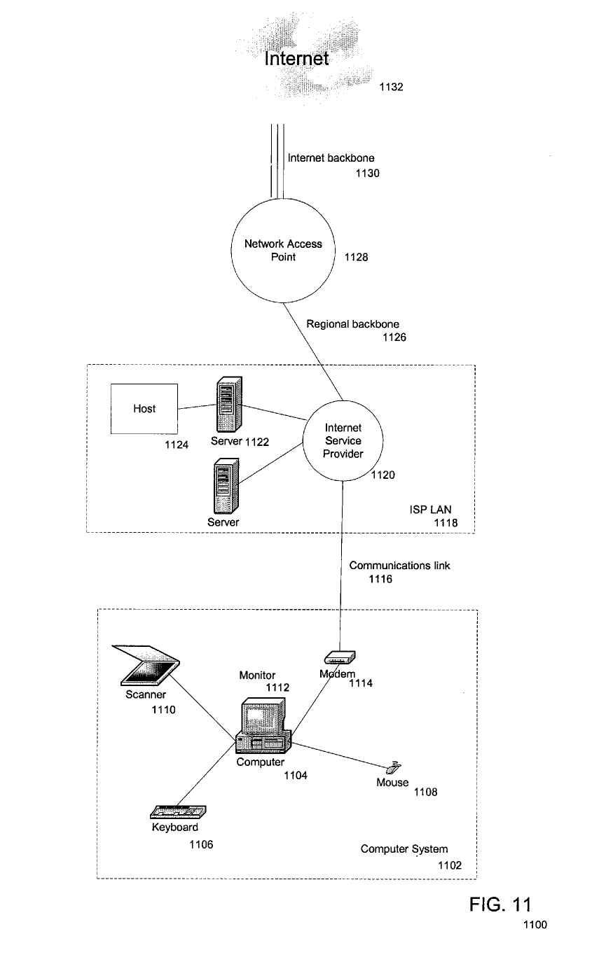

FIG. 11 is a diagram 1100 of a computer system and a global computer network upon which embodiments of the invention may be implemented. According to one embodiment, a computer 1104 can be interfaced to various input and output devices via an internal system bus within the computer. The bus is used to convey information amongst internal and external integrated components making up the computer system. The input and output devices permit communication between the computer system and the user. A keyboard 1106 and cursor control/mouse 1108 are various types of input devices used to input information and or to interact with the computer system. Another type of input device is a scanner 1110 which can be used to digitize printed material such as graphics and photographs. The digitized item can then be saved and utilized electronically within the computer system as a graphic file format. An output device used within the computer system is a monitor 1112 or cathode ray tube (CRT) which is used to display information from the computer system 1102 to the user. Another component making up the computer system 1102 is a communications interface 1114 which provides a two-way data communications connection to a communications link 1116. One such type of communications interface is a modem 1114 which can be internal or external to the computer. The modem 1114 permits the user to communicate with an Internet Service Provider (ISP) 1120 via a communications link 1116. One type of communications link 1116 is a dial-up connection using a phone line. Another type is a broadband connection which utilizes a broadband modem and provides higher speed communications through the use of a digital subscriber line (DSL), digital cable or satellite technology to name a few.

The communication link 1116 is the beginning of a large communications network. The communications link 1116 connects the user to an Internet service provider (ISP) 1120 which can be part of a local area network (LAN) 1118. The ISP 1120 is an institution that provides the user with access to the Internet 1132 usually in exchange for a user fee. The ISP 1120 can be made up of one or more servers 1122. The server 1122 is a computer that allows computers in a network to have a shared resource which could be in the form of printers, files or applications. The server 1122 can be referred to as a host 1124 when it is on a network and is a repository for services available to other computers on the network. As a host 1124 on the Internet 1132, the server 1122 can be utilized to store and make available to other computers in the network, a collection of web pages and other information. A web page is a document configured for viewing in a web browser and is usually written in Hypertext Markup Language (HTML), coding language used to create Hypertext documents. The web browser used to view a web page is a software program typically stored and used on the user's computer system 1102.

Multiple ISP's 1118 eventually link to a Network Access Point (NAP) 1128, via a regional backbone 1126 communication channel and hardware, where communication traffic may jump from one backbone to another. Several high-level networks interconnect via multiple NAP's 1128 using the Internet backbone 1130. Backbones are high speed communication channels typically comprised of fiber optic trunk lines capable of transmitting bytes of data at an extremely high rate of speed. This immense compilation of interconnected networks that are connected using the Transmission Control Protocol/Internet Protocol (TCP/IP) and originally evolving from the Advanced Research Projects Agency Network (ARPANet) is called the Internet 1132. The Internet 1132 connects thousands of smaller networks into a global network.

Since the invention disclosed herein may be embodied in other specific forms without departing from the spirit or general characteristics thereof, some of which forms have been indicated, the embodiments described herein are to be considered in all respects illustrative and not restrictive. The scope of the invention is to be indicated by the appended claims, rather than by the foregoing description, and all changes, which come within the meaning and range of equivalency of the claims, are intended to be embraced therein.

1. A system for enabling an Internet proprietor (owner) to rent an asset to one or more Internet renters, using the Internet, comprising:
an interface for receiving an asset rental package from the Internet proprietor, the package including the asset for rent, the proprietor's identification, and proprietor's financial transaction data; the interface also including a renter identifier;
Proprietor asset storage to store the asset rental package;
renter storage to store the renter identifiers an identifier extractor to extract the renter identifier; and
a notifier to notifier the renter, based upon the renter identifier, that the asset for rent is ready to be used by the renter, wherein, the system also notifies the proprietor to make the asset for rent available to the renter.

2. The system of claim 1, further comprising a module for automatically debiting the proprietor and crediting the website for a listing fee; to debit the renter and credit the proprietor for the rental fee; and to debit the proprietor and credit the website for the final fee associated with the rental transaction.

3. A method of providing at least one asset for rent by an owner via Internet, the method comprising:
establishing a website in the Internet, the website is used as an interface for the owner to provide the asset for rent and for a renter to rent the asset;
checking membership of the owner by the website, if the owner is not a member of the website, the owner is prompted to select a unique user name and password as well as to input personal and financial transaction data to establish a membership for the owner;
receiving and storing information of the asset by the website, the information of the asset is inputted by the owner of the asset;
confirming the decision of the owner on the asset for rent by the website;
if confirmed by the owner, automatically debiting the owner and crediting the website for a listing fee; and
identifying the asset for rent by the website and listing information pertaining to the asset, whereby the asset is made available to rent in the website via Internet.

4. The method of claim 3, wherein the asset for rent is selected from the group consisting of exercise equipment, tools, equipment, instruments, merchandise, plants, animals, electronic goods, recreational items, party items, entertainment items, and motorized vehicles.

5. The method of claim 3, further comprising a step of obtaining a rental activity history of the owner.

6. The method of claim 5, wherein the rental activity history is pertaining to an item owned by the owner and currently rented by a renter and associated details thereof.

7. The method of claim 5, wherein the rental activity history is pertaining to an item owned by the owner and rented by a renter over a period of time and associated details thereof.

8. A method of renting at least one asset by a renter via Internet, the asset is made available to rent by an owner, the method comprising:
establishing a website in the Internet, the website is used as an interface for the owner to provide the asset for rent and for the renter to rent the asset;
checking membership of the renter by the website, if the renter is not a member of the website, the renter is prompted to select a unique user name and password as well as to input personal and financial transaction data to establish the membership for the renter;
when finding the asset wanted to rent, corresponding by the renter via the website with the owner of the asset to exchange information regarding to the asset; and
electronically completing rental transaction if the renter decides to rent the asset, whereby the financial transaction for renting the asset is automatically initiated and executed.

9. The method of claim 8, wherein the completing rental transaction step comprising:
identifying the asset by the renter;
identifying rental duration of the asset by the renter;
identifying starting date and time for the rental of the asset by the renter; and
providing user name and password of the renter to the website by the renter.

10. The method of claim 8, wherein after the step of checking the membership of the renter, searching the website by the renter for the asset wanted to rent. (THE NUMBERING ON THIS APPEARS TO BE INCORRECT—NEED TO CHECK)

11. The method of claim 8, wherein the asset is selected from the group consisting of exercise equipment, tools, equipment, instruments, merchandise, plants, animals, electronic goods, recreational items, party items, entertainment items, and motorized vehicles.

12. The method of claim 8, further comprising a step of obtaining a rental activity history of the renter.

13. The method of claim 11, wherein the rental activity history of the renter is pertaining to an item which is currently rented by the renter and associated details thereof.

14. The method of claim 11, wherein the rental activity history of the renter is pertaining to an item which has been rented by the renter over a period of time and associated details thereof.

15. A method of listing at least one asset wanted to rent by a renter via Internet, the method comprising:
establishing a website in the Internet, the website is used as an interface for the renter and an owner of the asset;
checking membership of the renter by the website, if the renter is not a member of the website, the renter being prompted to select a unique user name and password as well as to input personal and financial transaction data to establish the membership for the renter;
searching the website, receiving a searching criteria inputted from the renter and searching through the website for the asset wanted to rent; and
saving the searching criteria in the website by the renter if the asset wanted to rent is unavailable to rent in the website, whereby the asset wanted to rent by the renter is listed in the website as an asset wanted and unavailable to rent.

16. The method of claim 15, wherein the asset is selected from the group consisting of exercise equipment, tools, equipment, instruments, merchandise, plants, animals, electronic goods, recreational items, party items, entertainment items, and motorized vehicles.

17. The method of claim 15, further comprising a step of obtaining a rental activity history of the renter.

18. The method of claim 17, wherein the rental activity history is pertaining to an item which is currently rented by the renter and associated details thereof.

19. The method of claim 17, wherein the rental activity history is pertaining to an item which has been rented by the renter over a period of time and associated details thereof.

20. A method of providing an asset for rent by an owner and renting the asset by a renter via Internet, the method comprising:
establishing a website in the Internet, the website is used as an interface for the owner to provide the asset for rent and for the renter to rent the asset;
checking membership of the owner by the website, if the owner is not a member of the website, the owner is prompted to select a unique user name and password as well as to input personal and financial transaction data to establish a membership for the owner;
in the website, receiving and storing information of the asset inputted from the owner;
confirming the decision of the owner of the asset for rent by the website;
if confirmed by the owner, automatically debiting the owner and crediting the website for a listing fee;
identifying the asset for rent by the website and listing information pertaining to the asset, whereby the asset is made available to rent in the website via Internet;
checking membership of the renter by the website, if the renter is not a member of the website, the renter is prompted to select a unique user name and password as well as to input personal and financial transaction data to establish the membership for the renter;
when finding the asset wanted to rent, corresponding by the renter via the website with the owner of the asset to exchange information regarding to the asset; and
electronically completing rental transaction if the renter decides to rent the asset, whereby the financial transaction for renting the asset is automatically initiated and executed.

21. The method of claim 20, wherein the completing rental transaction steps comprising:
identifying the asset by the renter;
identifying rental duration of the asset by the renter;
identifying starting date and time of the rental of the asset by the renter; and
providing user name and password to the website by the renter.
